(19) United States
(12) Patent Application Publication
(10) Pub. No.: US 2001/0032212 A1
(43) Pub. Date: Oct. 18, 2001

(54) Method for managing personal information

(76) Inventor: Iku Sano, Omiya-shi (JP)

Correspondence Address: VARNDELL & VARNDELL, PLLC, 106-A South Columbus Street, Alexandria, VA, 22314, US

(21) Appl. No.: 09/834,620

(22) Filed: Apr. 16, 2001

(30) Foreign Application Priority Data
Apr. 18, 2000 (JP) 2000-117106

(51) Int. Cl. G06F 17/30; G06F 15/16

(52) U.S. Cl. 707/104.1; 707/10; 709/217

(57) ABSTRACT

A method comprising the steps of (A) a step that an information center stores registered members' personal information in a storage portion 9; (B) a step that a member obtains another member's business card 1 including the another member's identification number; (C) a step that the member transmits the another member's identification number together with the member's identification number to the information center via the Internet; and (D) a step that the information center transmits the another member's personal information to the member via the Internet.

### FIELD OF THE INVENTION

The present invention relates to a method for managing personal information, and more specifically, a method for storing, updating and providing personal information of registered members among these members. A registered member of the system of the present invention uses an information medium such as a business card, on which some predetermined items of information are printed, and an information center which every registered member can communicates with. The information center stores the personal information of a large number of registered members, and is accessible via a communication medium such as the Internet.

### DESCRIPTION OF THE RELATED ART

When a person has exchanged business cards with another person at first meeting, it is conventional that the obtained business card is stored simply in a business card holder. It is also conventional that the personal information printed on the obtained business card such as the another person's name, the company name, the office address and so on is inputted into a memory medium such as HDD (hard disk drive) or FD (floppy disk) by using a manual inputting means of a personal computer, so that the information can be stored in the memory medium.

However, when the personal information on the business card is partly changed after the first meeting, the person cannot know the changed items of the information, unless the person is informed of the changed items from the another person or someone else. Thus, there might occur cases that the person cannot make a contact with the another person on the telephone, because the another person has already moved to another office. Also, there might occur cases that the person speaks to the another person, who has been promoted to a higher position after the first meeting, referring the another person's former position, and this makes the another person feel unpleasant. Another problem is that when the person is informed of the changed items of the another person's information, the information of the another person which has been stored in the memory medium has to be changed by an inputting means of a personal computer. This work takes much time and is also tedious.

Japanese Patent Publication no. H6-131363-A discloses a technology using a seal for solving those problems. Firstly, a registered member, who has a first information card such as a business card on which some predetermined items of information including the card identification information is printed as a seal, receives a second information card such as a business card from another registered member or associated member, unglues the seal from the first information card, and then put the unglued seal on the second information card. Thus, a one-to-one correspondence between the first and the second information cards is established. The registered member, who has obtained the second information card, transmits the information printed on the second information card together with the information of the first information card printed on the seal to an information center via a transmitting means, and then renews members information files which include registered members-related information and associated members-related information.

When the registered member transmits the information to the information center, the registered member can decide a class value which determines the scope of the member's personal information accessible by the another member or associated member who has obtained the registered member's first information card, and then can register the class value at the members information files.

In the art of the Japanese Patent Application no. H6-131363, there are some disadvantages. One disadvantage is that a seal has to be put on the first information card (i.e. business card) beforehand. Also, the seal has to be unglued from the first information card and has to be put on the second information card (i.e. business card). Furthermore, when the registered member determines the scope of the registered member's personal information accessible by the another member or associated member, the registered member has to decide a class value and has to register the class value at the members information files of the information center at the time that the registered member communicates with the information center.

### SUMMARY OF THE INVENTION

An object of the present invention is to provide a method for managing personal information that solves the problems of the prior art. Namely, the present invention provides a method for managing personal information which enables a user (i.e. a registered member) to obtain another member's updated personal information from a storage device which stores a lot of registered members' personal information in an information center via a transmitting means such as the Internet at any time only by exchanging business cards with another member and using a personal computer and peripheral devices including a communications device without putting on a seal on an information medium such as a business card.

The method for managing personal information of the present invention is characterized in that a user, who is a registered member, receives other registered members' personal information such as business-related information and private life-related information, which is stored in a storage means of an information center and can be updated, from the information center by using the user's communications terminal unit such as a modem connected to the user's personal computer via a communications means such as the Internet, and in that the method comprises:

a step that the information center stores the personal information of the registered members as members' personal information files in the storage means of the information center in advance;

a step that the user obtains an information medium on which transmitting ciphers including the another member's identification cipher, and transmits the transmitting ciphers to the information center; and

a step that the information center transmits to the user the another member's personal information which is selected based on the another member's identification cipher in the transmitting ciphers which has been transmitted to the information center from the user.

According to the present invention, the user can obtain the another member's updated personal information via a communications means such as the Internet at any time after the user obtains the another member's information medium such as a business card which includes the another member's identification cipher.

The another member's personal information which has been transmitted to the user s communications terminal unit from the information center can be stored in the user's storage portion such as HDD or can be only represented on the user's display (CRT).

The examples of the another member's information medium include a business card, a post card such as a New Year's greeting card, a mail envelope and a document file to be stored in a storage medium such as FD (floppy disk), and digital code transmissible on a communications means such as the Internet.

Also, in the case that the another member's transmitting ciphers are printed on a business card, the another member's transmitting ciphers can be represented in a form of a bar code or in a form of marks (i.e. numerals, alphabets and so on) which can be inputted by an inputting means such as a keyboard of a personal computer.

In the case that the another member' s transmitting ciphers are represented in a form of marks which can be inputted by an inputting means, the user can input the another member's transmitting ciphers by an inputting means such as a keyboard of the user's personal computer. In the case of that the another member's transmitting ciphers are represented in a form of bar codes, the user can input the another member's transmitting ciphers by a bar code reader. Furthermore, in the case that the another member's transmitting ciphers are represented both in a form of marks which can be inputted by an inputting means and in a form of bar codes, the user can input the another member's transmitting ciphers by an inputting means such as a keyboard or a bar code reader.

In the preferred embodiment of the present invention, the information center has s storage portion which can store at least two personal information files per member, and the another member's transmitting ciphers include the another member's disclosure cipher for specifying the another member's file to be transmitted to the user.

In this case, the another member's personal information files may include a business-related file and private life-related file, or may include at least two business-related files. The typical example of at least two business-related files includes a personal information file with regard to Corporation A and a personal information file with regard to Corporation B in the case that the another member owns two companies, that is to say, Corporation A and Corporation B. Each of these two business-related files includes the information such as the another member's title (i.e. president, CEO and so on), the telephone number and so on.

In the case that the another member's personal information files include a business-related file and a private life-related file, the another member can prepare three types of business cards. Three types of business cards include a business card having a disclosure cipher for disclosing only the business-related information, a business card having a disclosure cipher for disclosing only the private life-related information, and a business card having a disclosure cipher for disclosing both the business-related information and the private life-related information. When the another member exchanges business cards with the user at first meeting, the another member selects one type from the three types of business cards and hands over the selected one to the user, considering the human relationship or intimacy between the another member and the user. The business card which is handed over to the user includes the disclosure cipher for disclosing both the another member's business-related information and the another member's private life-related information, for example. Then, the user boots a software for managing personal information, which has been installed for carrying out the present invention, and inputs the transmitting ciphers, which consist of the another member's identification cipher and the another member's disclosure cipher, into the user's personal computer. The user transmits the another member's transmitting ciphers together with the user's identification cipher and the user's password to the information center, and receives the another member's personal information including the business-related information and the private life-related information, which has been selected based on the another member's transmitting ciphers, from the information center. After that, the user can obtain the another member's updated personal information in the storage portion of the information center at any time via a communications means such as the Internet by communicating with the information center, if only the another member updates the another member's personal information stored in the information center properly.

In the present invention, the user may have some classifications which are classified by a criterion such as types of industry in the user's storage portion, and then may store and updates other members' personal information in each of the classifications. Also, in the case that the user is a legal person (i.e. a corporation), anyone in the legal person can hold in common the personal information such as sections, positions and telephone numbers of all the other persons in the legal person.

In the method of the present invention, it is preferable to employ a measure for preventing a third party (i.e. a non-registered person) from communicating with the information center, even if the third party steals the user's identification cipher and the user's password.

From this point of view, it is preferable to add the following steps in the before-mentioned steps. Namely, the preferred embodiment of the present invention includes the steps of:

a step of storing a variable password both in the storage portion of the information center and in the storage portion of the user's personal computer;

a step that the information center changes the variable password automatically at the last time that the information center communicates with the user before the time that the information center transmits the another member's identification number and so on to the user, stores the changed variable password and also transmits the changed variable password to the user, and the user receives and stores the changed variable password in the storage portion of the user's personal computer;

a step that the user transmits the changed variable password, which has been stored in the storage portion of the user's personal computer, together with the transmitting ciphers on the information medium (i.e. business card) obtained from the another member to the information center;

a step that the information center checks the changed variable password transmitted from the user with the changed variable password which has been stored in the storage portion of the information center, and transmits the another member's personal information to the user provided that these changed variable passwords coincide to each other.

By using the variable password, the user can prevent a third party (i.e. non-registered person), who has stolen the user's identification cipher and the user's password, from communicating with the information center via a communication means such as the Internet using the personal computer of the third party.

In the present invention, the information center can transmit advertising information together with the another member's personal information to the user. The advertising information can be selected based on the user's personal information. For example, when the user changes the company name in the user's personal information to a foreign capital company, the advertising information can be, for example, the URL (Uniform Resource Locator) of an English education company. In this case, the English education company can transmits its URL only to the members who have high possibilities of becoming clients. The company for managing the system of the present invention can obtain advertising revenues and therefore can reduce the annual membership fee.

### BRIEF DESCRIPTION OF THE DRAWINGS

FIG. 1 is a schematic diagram showing an example of the method for managing personal information according to the present invention.

FIG. 2 is a schematic diagram showing the constitution of a user's personal computer.

FIG. 3 is a schematic diagram showing the constitution of the computer in the information center.

FIG. 4 is a flow chart showing a user's procedure for becoming a registered member of the system of the present invention.

FIG. 5 is an example of the membership card for a newly registered member.

FIG. 6 is an example of a user's business card.

FIG. 7 is a schematic diagram showing a flow of communications between a user and the information center.

FIG. 8A is the front half of a flow chart of an actual system for exploiting the method of the present invention.

FIG. 8B is the latter half of the flow chart continued from FIG. 8A.

### DETAILED DESCRIPTION OF THE EMBODIMENTS

Embodiments of the present invention are described below, referring to the drawings.

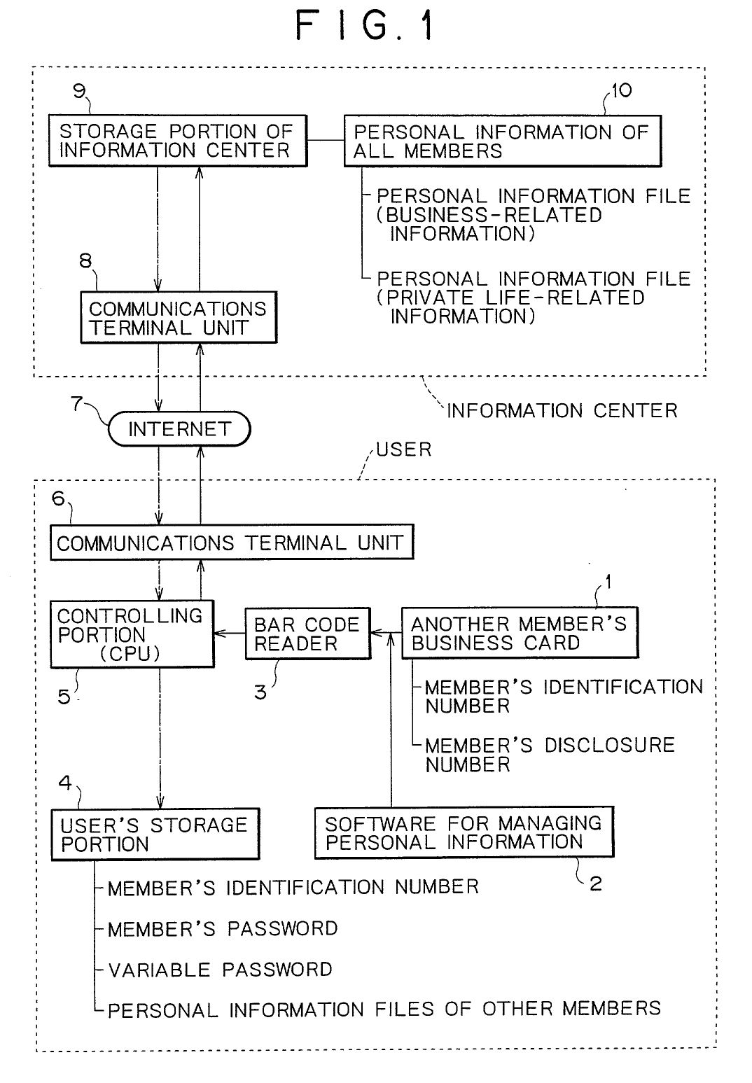

As shown in FIG. 1, a user, who is a member of the system of the present invention, receives a business card 1 from another member. Then the user starts up the software 2 for managing personal information which has been provided by a software company and has been previously downloaded into his personal computer. The another member's identification number and the another member's disclosure number for defining the scope of disclosing the another member's personal information, which are printed on the another member's business card, are read out by means of a bar code reader 3.

A controlling portion (CPU; Central Processing Unit) 5 transmits the another member's identification number and the another member's disclosure number, which have been inputted into the user's personal computer by the bar code reader 3, together with the user's identification number, the user's password and the variable password, which has been stored in the user's storage portion 4 (i.e. HDD) of the user's personal computer, from the user's communications terminal unit (modem or terminal adapter (TA)) 6 to the communications terminal unit 8 of the information center via the Internet 7.

When the information center receives the information transmitted from the user, the information center checks the information from the user with the corresponding information stored in the storage portion 9 of the information center. Provided that the information transmitted from the user coincides exactly with the information stored in the information center, the another member's personal information files are selected from all the personal information files 10 in the storage portion 9 based on the another member's disclosure number for disclosing, for example, both the another member's business-related information and private life-related information. The selected files, that is, the another member's business-related information file and the another member's private life-related information file, are transmitted from the communications terminal unit 8 of the information center to the communications terminal unit 6 of the user's personal computer via the Internet 7. The user receives the another member's files transmitted from the information center, and stores the files in the storage portion 4.

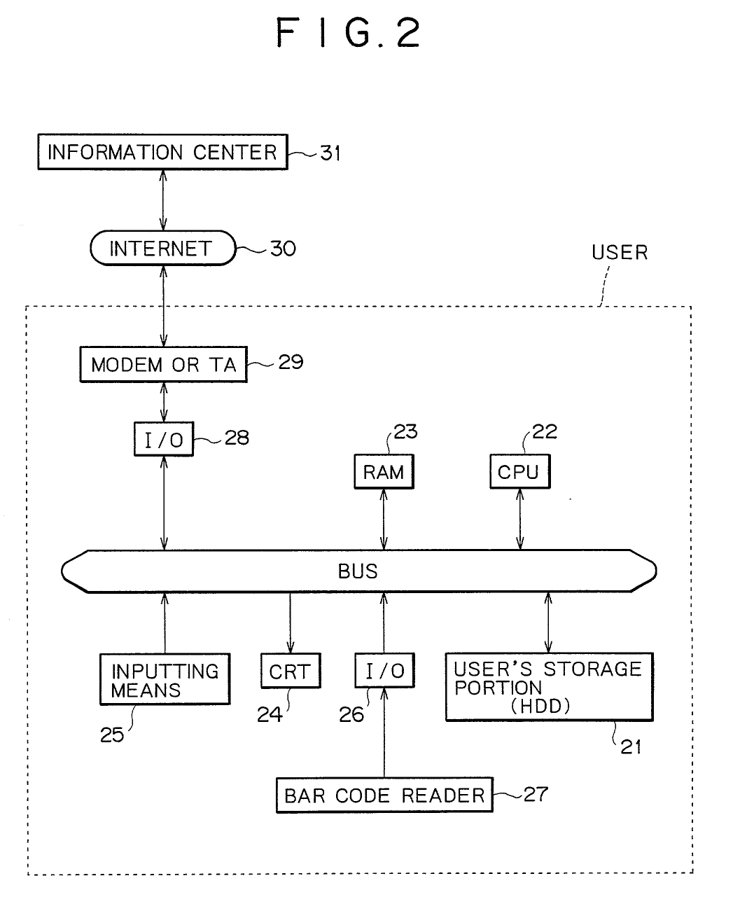

FIG. 2 shows a block diagram which represents the elements of the user's personal computer. The user's personal computer comprises a storage portion (memory such as HDD) 21, CPU (central processing unit) 22, RAM (memory) 23, CRT (display) 24, an inputting means (keyboard) 25 and a bar code reader 27 connected to an interface (I/O) 26. The storage portion 21 is used for installing the software for managing personal information, and is also used for storing other members' personal information.

The user's personal computer is connected to the communications terminal unit 29 such as a modem or a terminal adapter through a serial interface (I/O) 28. The user can communicate with the information center 31 via the Internet 30 by using the personal computer.

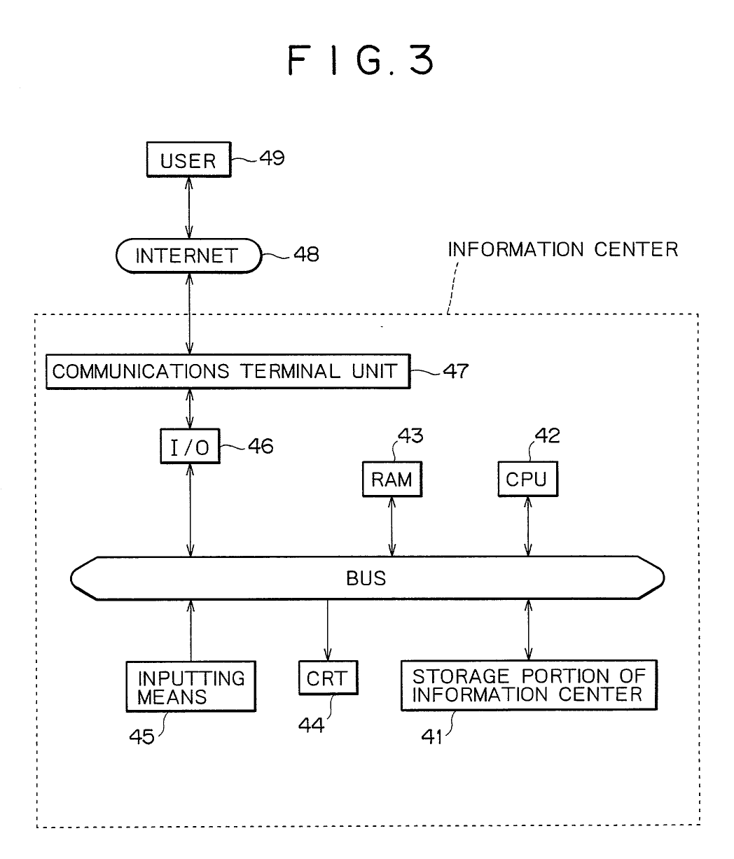

On the other hand, as shown in FIG. 3, the computer of the information center comprises a storage portion (memory having large capacity) 41, CPU (central processing unit) 42, RAM (memory) 43, CRT (display) 44, and an inputting means (keyboard) 45. The storage portion 41 is used for storing all the information such as all members' identification number, all members' password, all members' business-related and private life-related information and so on.

The computer of the information center is connected to a communications terminal unit 47 through a serial interface (I/O) 46. The computer of the information center can communicate with the user 49 via the Internet 48.

The staff of the information center can check all the information stored in the storage portion 41 by means of an inputting means 45 and CRT 44 at any time.

All the personal information stored in the storage portion 41 can be classified into at least two personal information files for each of the members. Each of the files of a member can be readout, or in other words, can be accessed independently. Also, two or more files of the files of a member can be read out simultaneously. The term “personal information file” means a minimum set of personal information of a member which cannot be divided into computer-readable files.

A personal information file comprises, for example, a business-related file and a private life-related file of a member. A business-related file includes, for example, a portrait (photograph) of the member, the company name, the office address, the department or section that the member works in, the member's position or title in the company, the telephone number, the e-mail address, the member's self-introduction, and other business-related matters. Private life-related file includes, for example, the home address, the telephone number, the details of the member's family including self-introductions and hobbies of the member's family, mourning information, and other private life-related matters. The private life-related information can be divided into two or more files.

The personal information file of a member can include one or more business-related files without including a private life-related file. Also, the personal information file of a member can include only one file which includes both the business-related information and the private life-related information.

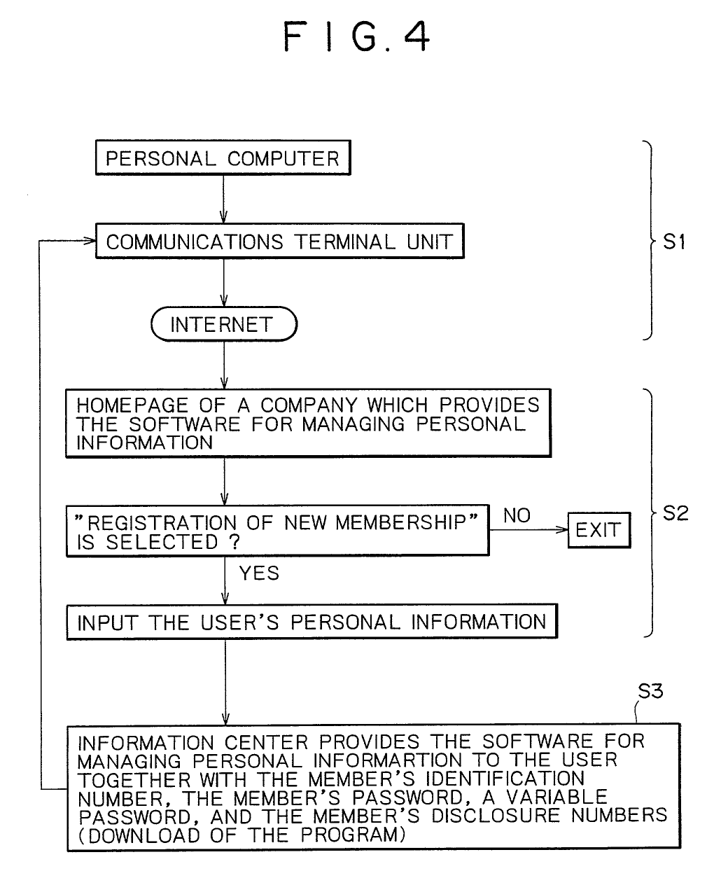

A user can become a member of the system of the present invention by carrying out an admission procedure shown in FIG. 4. At first, a user accesses the homepage of a company which provides the software for managing personal information via the Internet by using the user's personal computer and a communications terminal unit connected to the personal computer (STEP 1, hereinafter referred to S1). The user selects a screen for new member admission procedure in the homepage, and inputs specified items of the user's personal information such as the user's name, address, telephone number, credit card number, and so on into the screen for inputting this information (STEP 2). After those data are inputted, the company which provides the software for managing personal information transmits the program of the software together with the user's identification number, the user's password, the user's variable password and the user's disclosure numbers for specifying the files to be disclosed to other members to the user (STEP 3). The user stores the program of the software for managing personal information in the user's storage portion (i.e. memory such as HDD) of the user's personal computer. The user's password can be changed afterward at any time by the user for ensuring security.

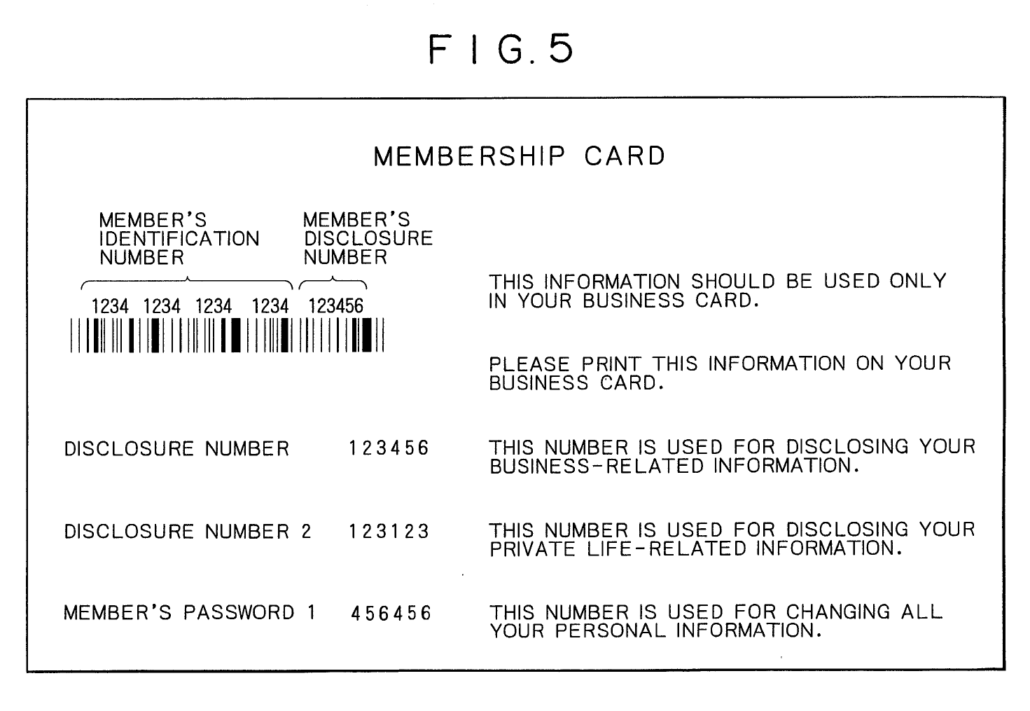

The information which has been stored in the user's storage portion includes the information of the user's membership card shown in FIG. 5. The membership card can be printed out as shown in FIG. 5 by a printer connected to the personal computer. In the upper portion of the membership card shown in FIG. 5, the user's identification number and the user's disclosure number are printed in the forms of numerals as well as bar codes. Namely, each of the user's identification number and the user's disclosure number is represented as numerals, and is also represented as a bar code which corresponds to the numerals. In FIG. 5, the user's disclosure number (123456) printed on the membership card represents that the user discloses only the business-related information to other members.

The user's disclosure numbers for defining the scope of disclosure differently are also printed on the membership card. For example, the “disclosure number 2” is a disclosure number for disclosing only the private life-related information such as the home address. If the user prints only the “disclosure number” (123456) shown in FIG. 5 on a business card, only the business-related information will be disclosed to other members. If the user prints only the “disclosure number 2” (123123) shown in FIG. 5 on a business card, only the private life-related information such as the home address will be disclosed to other members. If the user prints both the “disclosure number” (123456) and the “disclosure number 2” (123123) shown in FIG. 5 on a business card by printing them in series (123456123123), both of the business-related information and the private life-related information will be disclosed to other members. If the user does not print any of these disclosure numbers on a business card, the user's personal information won't be disclosed at all to other members. Accordingly, four kinds of business cards can be prepared according to the scope of the disclosure to other members.

The user's password 1 (456456) shown in FIG. 5 is used for changing any of the user's personal information, that is, the user's business-related information and the user's private life-related information.

The user's identification number and/or disclosure number can be represented only by numerals or only by a bar code. Each of the user's disclosure numbers can be always represented as a number of six figures, for example. In this case, the disclosure number for disclosing both the user's business-related information and the user's private life-related information is not a combination of the number for disclosing the business-related information and the number for disclosing private life-related information. For example, in the case that the disclosure number for disclosing the user's business-related information is represented as “123456”, and the disclosure number for disclosing the user's private life-related information is represented as “121212”, the disclosure number for disclosing both the user's business-related information and the user's private life-related information can be represented as “343434”. A disclosure number can be represented as a number of any figures, for example, 4 to 7 figures.

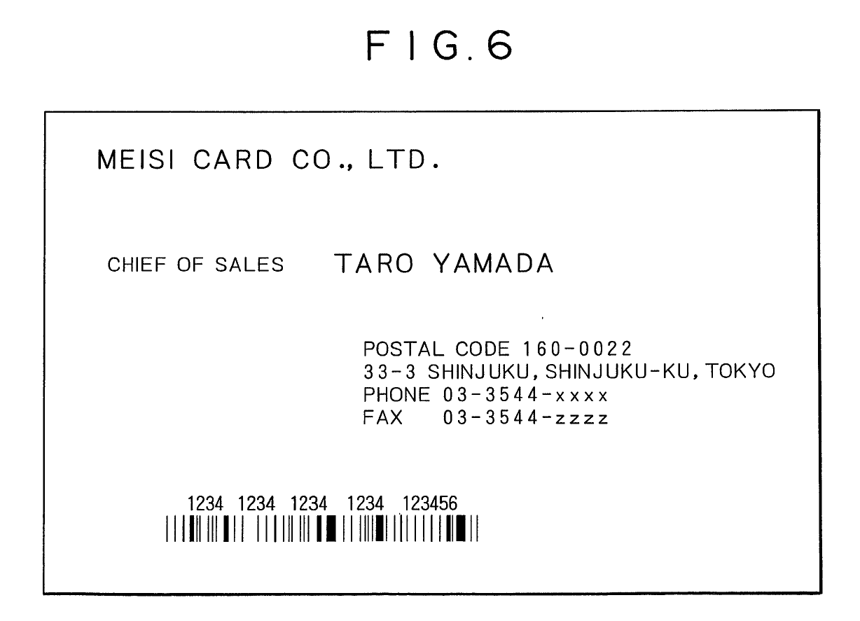

A user can have two kinds of business cards, for example. One of them is a business card for providing only the user's business-related information file, and the disclosure number for disclosing only the user's business-related information is printed on the business card. The other is a business card for providing only the user's private life-related information file, and the disclosure number for disclosing only the user's private life-related information is printed on the business card. When the user exchanges business cards with another member at first meeting, the user selects one business card from two kinds of business cards considering the human relationship between the user and the another member, and hands over the selected business card to the another member. FIG. 6 shows an example of a business card on which numerals and bar codes are printed for representing the user's identification number and the user's disclosure number. It is convenient to distinguish between some kinds of business cards by colors.

There is a possibility that a third party (i.e. a person who is not a registered member) steals the user's identification number and the user s password, and tries to obtain the personal information stored in the user's storage portion from the storage portion of the information center. In the present invention, a variable password is used for a safeguard against such a situation. The variable password for preventing a third party from obtaining the members' personal information stored in the user's storage portion will be explained below together with the explanation of the procedures that the user updates the information of other members stored in the user's storage portion.

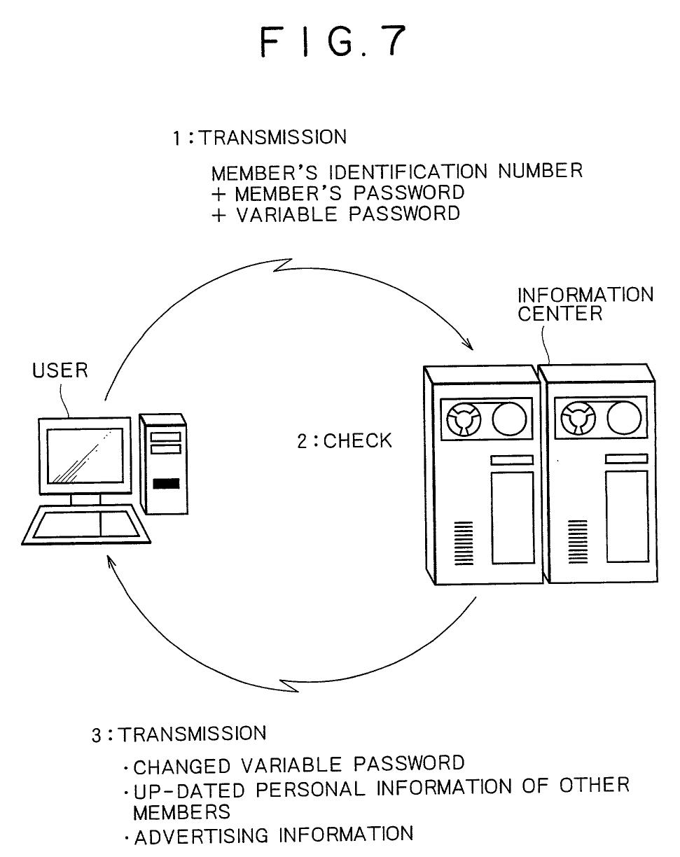

To update all the personal information of other members stored in the user's storage portion, the user transmits the user's identification number, the user's password, the variable password and a signal for demanding the renewal of other members' personal information, which is represented as a cipher comprising numerals and/or alphabets of six figures for example, to the information center as shown in FIG. 7. The information center checks the user's identification number, the user's password and the variable password transmitted from the user with those stored in the storage portion of the information center. Then the information center transmits the updated personal information of other members along with some selected advertising information to the user. The advertising information may be selected based on the user's personal information. For example, if the user's personal information includes the information of “a man of 18 to 38 years old”, advertising information of some sports cars sponsored by a car dealer may be a suitable one. It is preferable that the changed items of the personal information of other members, which is stored in the user's storage portion and which has been changed recently (for example, within one month) in the storage portion in the information center, is represented as a list on the display of the user's computer when the user communicates with the information center.

When the user communicates with the information center, the user's variable password in the storage portion of the information center is changed and is transmitted to the user. Thus, the changed variable password is stored in the user's storage portion as well as in the storage portion of the information center. After that, when the user communicates with the information center again, the user transmits the changed variable password together with other information to the information center. The information center checks the changed variable password transmitted from the user with the changed variable password stored in the storage portion of the information center. If these variable passwords coincide with each other, the information transmitted to the information center is surely from the user's personal computer. On the contrary, if these variable passwords do not coincide with each other, the information transmitted to the information center is from a personal computer of a third party who has stolen the user's identification number and the user's password.

Thus, when a third party, who has stolen the user's identification number and the user's password, communicates with the information center and tries to obtain the members' personal information stored in the user's storage portion from the information center, such access will be rejected by the information center, because the user's variable password has been already changed and is different from the former variable password which is now transmitted from the third party. In this way, the third party cannot acquire the personal information of the members. Additionally, illegal copying of the software for managing personal information can be protected by employing this “variable password”.

Usually, the information center changes the user's variable password at every time that the user communicates with the information center. The variable password can be changed at random or can have some meaning such as the password “1425” which means the time “14:25” that the user starts to communicate with the information center.

The storage portion of the information center stores all the personal information of all the members. In the storage portion of the information center, any of the personal information can be changed, in other words, can be updated if necessary. When a user wants to change the user's personal information, the user boots the software for managing personal information at the user's personal computer, and then communicates with the information center to update the user's personal information such as the new department which the user has moved, the new position, the new telephone number and so on. In this case, the user can use the user's variable password to prevent a third party from trying to change the user's personal information in the storage portion of the information center.

Alternatively, the user can send a written document to request the staff of the information center to change the user's personal information. The staff of the information center inputs the user's updated personal information into the storage portion of the information center based on the written document from the user.

The user's identification number, the user's password, the user's disclosure numbers and the variable password can be represented in any computer-readable form. For example, a cipher consisting of numerals and/or alphabets of 4 to 10 figures, which can be inputted by an inputting means (i.e. keyboard) of a personal computer, can be used.

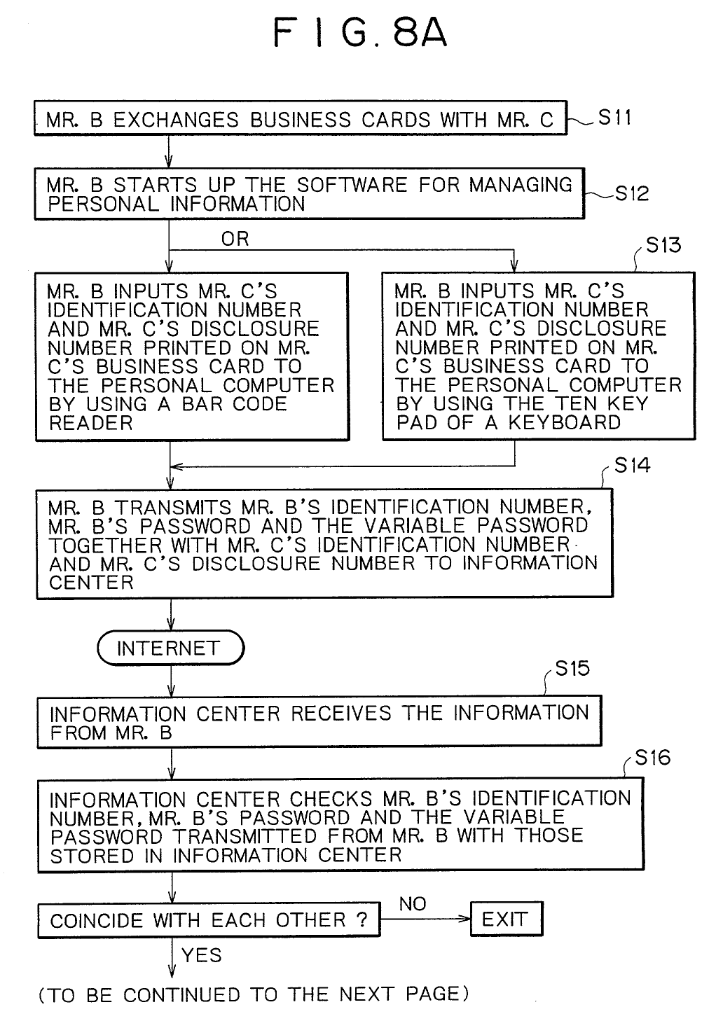

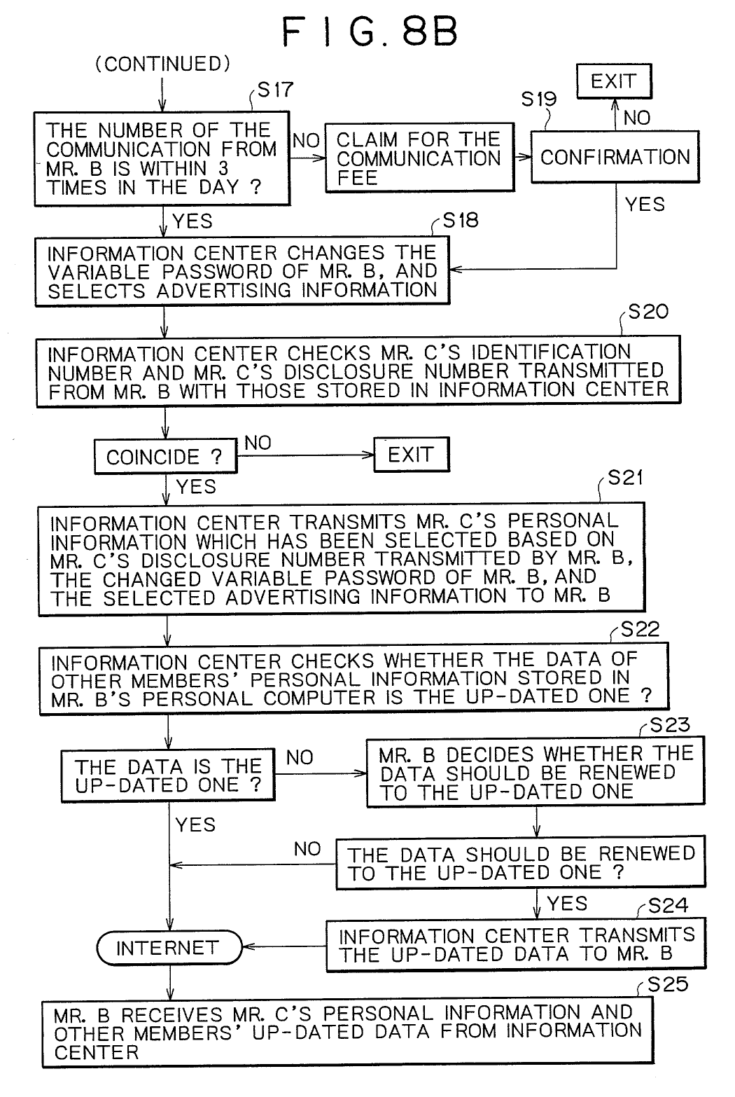

An example of the procedure for acquiring personal information of other members is explained below, referring to FIGS. 8A and 8B. In FIG. 8A, a user (Mr. B), who is a member of the system of the present invention, exchanges business cards with another member (Mr. C), and obtains a business card from Mr. C. (STEP 11, referred to “S11” in FIG. 8A). The identification number and the disclosure number of Mr. C are printed on the business card of Mr. C. Mr. B can carry out the following procedure immediately after obtaining the business card of Mr. C, or can carry out the following procedure after he collects some business cards.

Mr. B starts up his software for managing personal information (STEP 12). Then, Mr. B reads out the identification number and the disclosure number of Mr. C printed on the business card of Mr. C by using a bar code reader. Alternatively, Mr. B can input these numbers by using a ten key pad of a keyboard (STEP 13).

Next, Mr. B transmits the identification number, the password and the variable password of Mr. B along with the identification number and the disclosure number of Mr. C to the information center via the Internet (STEP 14). The information center receives the information from Mr. B (STEP 15), and checks the identification number, the password and the variable password of Mr. B with those stored in the storage portion of the information center (STEP 16).

After confirming that the information from Mr. B is exactly the same as those stored in the information center, the information center checks whether the number of times of the communications from Mr. B is above three times in the day or not (STEP 17). If the number of times is three or less in the day, the information center changes the variable password, and selects advertising information to be sent to Mr. B based on Mr. B's personal information such as his favorite hobbies (STEP 18). On the contrary, if the number of times is four or more in the day, the information center charges Mr. B for the communications fee, confirms that Mr. B complies with the charge (STEP 19), and then carries out the same procedure as described above (STEP 18).

The information center checks the identification number and the disclosure number of Mr. C transmitted from Mr. B with those stored in the storage portion of the information center (STEP 20). If the check turns out that the numbers from Mr. B coincide exactly with the numbers stored in the information center, the personal information files of Mr. C selected from all the files of Mr. C based on the disclosure number of Mr. C, the changed variable password, and advertising information are transmitted to Mr. B (STEP 21). The personal information of Mr. C includes the business-related information and the private life-related information of Mr. C in the case that the disclosure number of Mr. C transmitted from Mr. B is the number for disclosing both the business-related information and the private life-related information of Mr. C.

The information center checks whether the personal information of other members stored in the personal computer of Mr. B is the updated one or not (STEP 22). If the personal information of other members is not the updated one, the information center asks Mr. B whether Mr. B updates the information of other members or not (STEP 23). After confirming Mr. B's approval, the information center transmits the updated information to Mr. B (STEP 24).

Mr. B receives the selected personal information files of Mr. C from the information center via the Internet and stores the information in the storage portion of Mr. B. Also, Mr. B has a look at the advertising information on the display (CRT), and accesses a homepage of a company which Mr. B takes an interest in (STEP 25). Mr. B can prevent a third party, who has stolen Mr. B's identification number and Mr. B's password, from communicating with the information center even if such a situation occurs, because Mr. B receives a changed variable password from the information center at every time that Mr. B communicates with the information center, whereas the third party cannot know the changed variable password.

Mr. C might change his thought after exchanging business cards with Mr. B. For example, Mr. C handed over a business card for disclosing both his business-related information and his private life-related information to Mr. B. After that, Mr. C has changed his thought to disclose only his business-related information to Mr. B. In this case, Mr. C can communicate with the information center to designate Mr. B based on the business card of Mr. B and to change the scope of disclosing his personal information to Mr. B. Also, Mr. C can suspend the disclosure of his personal information to Mr. B by communicating with the information center. Furthermore, Mr. C can obtain the list of the members, who exchanged business cards with Mr. C, from the information center and check the scope of disclosing his personal information to these members.

What is claimed is:

1. A method for managing personal information which comprises the steps of:
a step that an information center stores personal information of registered members as members' personal information files in a storage means of the information center in such a way that each of the members' personal information files can be updated;
a step that a registered member obtains an information medium which has transmitting ciphers including another registered member's identification cipher, and transmits the transmitting ciphers to the information center; and
a step that the information center transmits to the registered member the another registered member's personal information files which have been selected based on the another registered member's identification cipher in the transmitting ciphers.

2. A method for managing personal information according to claim 1, wherein the information medium is a business card.

3. A method for managing personal information according to claim 1, wherein the transmitting ciphers are represented in a form of bar codes.

4. A method for managing personal information according to claim 1, wherein the transmitting ciphers are represented in a form of marks which can be inputted by an inputting means.

5. A method for managing personal information according to claim 1, wherein the information center is capable of having at least two personal information files per registered member, and the transmitting ciphers include a disclosure cipher for specifying the another registered member's personal information file to be transmitted to the registered member.

6. A method for managing personal information according to claim 5, wherein the information medium is a business card.

7. A method for managing personal information according to claim 5, wherein the transmitting ciphers are represented in a form of bar codes.

8. A method for managing personal information according to claim 5, wherein the transmitting ciphers are represented in a form of marks which can be inputted by an inputting means.

9. A method for managing personal information according to claim 5, wherein the another member's personal information files include a business-related file and a private life-related file.

10. A method for managing personal information according to claim 5, wherein the another member's personal information files include at least two business-related files.

11. A method for managing personal information according to claim 1, wherein the information center transmits advertising information, which has been selected based on the registered member's personal information, to the registered member together with the another member's personal information files.

12. A method for managing personal information according to claim 1, wherein the method further comprises the steps of:
a step of storing a variable password in the storage means of the information center and in a storage means of the registered member independently;
a step that the information center changes the variable password automatically at the last time that the information center communicates with the registered member before the time that the information center transmits the another registered member's personal information files to the registered member, stores the changed variable password in the storage means of the information center, and transmits the changed variable password to the registered member, and the registered member receives and stores the changed variable password in the storage means of the registered member;
a step that the registered member transmits the changed variable password, which has been stored in the storage means of the registered member, together with the transmitting ciphers of the another registered member to the information center;
a step that the information center checks the changed variable password transmitted from the registered member with the changed variable password which has been stored in the storage means of the information center, and transmits the another member's personal information files to the registered member provided that these changed variable passwords coincide to each other.

13. A method for managing personal information according to claim 12, wherein the information medium is a business card.

14. A method for managing personal information according to claim 12, wherein the transmitting ciphers are represented in a form of bar codes.

15. A method for managing personal information according to claim 12, wherein the transmitting ciphers are represented in a form of marks which can be inputted by an inputting means.
